(19) United States
(12) Patent Application Publication
(10) Pub. No.: US 2022/0416315 A1
(43) Pub. Date: Dec. 29, 2022

(54) Metal Battery

(71) Applicant: Sumitomo Chemical Co., Ltd, Tokyo (JP)

(72) Inventors: Thomas Johannes Kugler, Cambridge (GB); Evan Nicholas Keyzer, Godmanchester (GB); Jack William Blincow, Godmanchester (GB)

(73) Assignee: Sumitomo Chemical Co., Ltd, Tokyo (JP)

(21) Appl. No.: 17/716,099

(22) PCT Filed: Oct. 8, 2020
(86) PCT No.: PCT/GB2020/052499

§ 371 Date: Apr. 8, 2022

(30) Foreign Application Priority Data
Oct. 8, 2019 (GB) 1914503.6
Mar. 24, 2020 (GB) 2004279.2

(51) Int. Cl. H01M 10/42; H01M 4/62; H01M 10/0525; H01M 10/0585; H01M 4/04; H01M 50/437; H01M 50/44; H01M 50/46

(52) U.S. Cl. CPC H01M 10/4235; H01M 4/62; H01M 10/0525; H01M 10/0585; H01M 4/0404; H01M 50/437; H01M 50/44; H01M 50/46; H01M 2004/027

(57) ABSTRACT

A metal battery, such as a lithium battery, includes an anode, an anode current collector in electrical contact with the anode, a cathode, a cathode current collector in electrical contact with the cathode, a separator disposed between the anode and cathode, a liquid electrolyte, and an anode protection structure. The anode protection structure includes an anode protection layer disposed between the anode and the separator. The anode protection layer includes a matrix and domains within the matrix. One of the matrix and domains contains a first material and the other of the matrix and domains contains a second material. The first material is less permeable by the electrolyte than the second material.

This application claims the priority of International Application PCT/GB2020/052499, filed Oct. 8, 2020, which claims the priority of GB1914503.6, filed Oct. 8, 2019, and GB2004279.2, filed Mar. 24, 2020, the disclosures of all of which are incorporated herein in their entireties, by reference.

### BACKGROUND

Embodiments of the present disclosure relate to metal batteries, in particular lithium batteries, and methods of forming the same.

Lithium metal batteries are known. However, secondary (i.e., rechargeable) lithium metal batteries have found limited application due in part to the tendency of lithium dendrites to form at the lithium anode during charging of the battery. Dendrite formation may result in a short circuit, with associated risks of combustion or explosion of the battery. Consequently, secondary lithium ion batteries are used more widely than secondary lithium batteries in applications where recharging of the battery is required.

U.S. Pat. No. 9,954,213 discloses an electrochemical cell containing an electronically and ionically conductive layer.

EP 3413380 discloses a lithium secondary battery having a multilayer protective structure.

US 2016/0218341 discloses a rechargeable lithium battery including an artificial solid electrolyte interphase membrane interposed between the lithium anode and the separator

US 2018/0294476 discloses a lithium secondary battery having a thin layer of a high-elasticity polymer having a recoverable tensile strain no less than 5%, a lithium ion conductivity no less than 10⁻⁶ S/cm at room temperature, and a thickness from 1 nm to 10 microns, wherein the high-elasticity polymer contains an ultrahigh molecular weight polymer having a molecular weight from 0.5×10⁶ to 9×10⁶ g/mole and is disposed between a lithium or lithium alloy and an electrolyte or separator-electrolyte assembly of the battery.

### SUMMARY

According to some embodiments of the present disclosure, there is provided a metal battery containing an anode; an anode current collector in electrical contact with the anode; a cathode; a cathode current collector in electrical contact with the cathode; a separator disposed between the anode and cathode; a liquid electrolyte; and an anode protection structure comprising an anode protection layer disposed between the anode and the separator.

The anode protection layer has a matrix and domains within the matrix.

One of the matrix and domains contains a first material and the other of the matrix and domains comprises a second material.

The first material is less permeable by the electrolyte than the second material.

Optionally, the matrix comprises the first material and the domains comprise the second material.

Optionally, the first material makes up a majority of the weight of the matrix and the second material makes up a majority of the weight of the domains.

Optionally, at least one of the first and second materials is a polymer.

Optionally, the first material and the second materials are polymers and a percentage mass increase of the second material upon immersion in a solvent of the electrolyte is at least two times that of the first material.

Optionally, the first material is a conjugated polymer.

Optionally, the conjugated polymer is not doped.

Optionally, the first material is a non-conjugated polymer.

Optionally, the second polymer is selected from polyacrylates; polymethacrylates; and poly(ethylene oxide).

Optionally, the anode protection layer is a phase-separated layer.

Optionally, the anode protection layer has an electrical conductivity of less than 1 S/cm.

Optionally, the metal battery is a lithium battery and the metal ion is a lithium ion.

Optionally, the anode protection structure consists of the anode protection layer.

Optionally, the anode protection layer is in direct contact with the anode layer.

In some embodiments, the separator is a porous structure which is not metal ion conducting. In some embodiments, the separator comprises a solid-state electrolyte or gel electrolyte.

Optionally, the metal battery is rechargeable.

According to some embodiments of the present disclosure, there is provided a method of forming a metal battery as described herein or an anode-free precursor thereof.

The method includes forming an anode protection structure including an anode protection layer over an anode current collector; and

providing a cathode in electrical contact with a cathode current collector, a separator between the anode current collector and the cathode, and a liquid electrolyte providing an ion conducting path between the anode current collector and the cathode.

Formation of the anode protection layer includes depositing the first material and the second material over the anode current collector.

Optionally, the first material and the second material are deposited from a formulation containing the first material, the second material and one or more solvents; and evaporating the one or more solvents.

Optionally, the first material and second material are dissolved in the formulation and are phase separated following deposition.

Optionally, an anode-free precursor is formed, and the anode is formed by application of a bias across the anode current collector and cathode current collector.

According to some embodiments, the present disclosure provides a metal battery precursor having an anode current collector; a cathode; a cathode current collector in electrical contact with the cathode; a separator disposed between the anode current collector and cathode; a liquid electrolyte; and an anode protection structure including an anode protection layer disposed between the anode current collector and the separator.

The anode protection layer has a matrix comprising a first material and domains comprising a second material within the matrix, the first material being less permeable by the electrolyte than the second material.

According to some embodiments, the present disclosure provides a method of forming a metal ion battery comprising applying a bias across the anode current collector and cathode current collector of a metal battery precursor as described herein to form a metal layer disposed between the anode current collector and the anode protection structure.

According to some embodiments, the present disclosure provides a metal battery having an anode; an anode current collector in electrical contact with the anode; a cathode; a cathode current collector in electrical contact with the cathode; a separator comprising glass fiber disposed between the anode and cathode; and an anode protection structure disposed between the anode and the separator. The separator is in direct contact with the anode protection structure.

Optionally, the anode protection structure is an anode protection layer.

Optionally, the anode protection layer comprises a polymer.

### DESCRIPTION OF DRAWINGS

FIG. 1 is a schematic representation of a cross-section of a metal battery having an anode protection layer according to some embodiments;

FIG. 2 is a schematic representation of the anode protection layer of the metal battery of FIG. 1;

FIG. 3 is a schematic representation of a method of forming a metal battery of FIG. 1 from a metal battery precursor;

FIG. 4A is a SEM image of a phase-separated layer formed from a blend of the polymers F8BT and PMMA;

FIG. 4B is an AFM phase contrast mode image of the phase separated layer of FIG. 4B;

FIG. 5A is a microscope image of an anode of a comparative battery formed using an anode protection layer of F8BT only;

FIG. 5B is a microscope image of an anode of a battery according to some embodiments formed using a 50:50 F8BT:PMMA anode protection layer;

FIG. 6 is a dark field microscope image of a phase-separated polystyrene:PEO 75:25 w/w film;

FIG. 7 is graph of coulombic efficiency vs. number of charge-discharge cycles for electrochemical cells with APL-coated copper anode charge collectors and lithium counter electrodes, according to some embodiments;

FIG. 8 is a graph of Coulombic efficiency vs. number of charge-discharge cycles for electrochemical cells with APL-coated copper anode charge collectors and lithium counter electrodes, according to some embodiments containing an anode protection layer formed from a phase-separated blend of F8BT (9,9-dioctylfluorene-bentothiadiazole AB copolymer) and PEO (50:50 w/w) or F8BT and PMMA (75:25) compared to a comparative battery having an anode protection layer formed from F8BT;

FIG. 9 is a graph of Coulombic efficiency vs. number of charge-discharge cycles for electrochemical cells with APL-coated copper anode charge collectors and lithium counter electrodes, according to some embodiments containing an anode protection layer formed from a phase-separated blend of F8BT and PEO (50:50 w/w) or from F8BT and PMMA (50:50 w/w);

FIG. 10 is a graph of Coulombic efficiency vs. number of charge-discharge cycles for electrochemical cells with APL-coated copper anode charge collectors and lithium counter electrodes, according to some embodiments containing an anode protection layer formed from a phase-separated blend of F8BT and PEO (75:25 w/w) or from F8BT and PMMA (75:25 w/w);

FIG. 11 is Nyquist plots of electrochemical cells with APL-coated copper anode charge collectors and lithium counter electrodes, according to some embodiments containing an anode protection layer formed from a phase-separated blend of F8BT and PEO or from F8BT and PMMA;

FIG. 12 shows graphs of discharge capacity vs. number of charge-discharge cycles for lithium batteries according to some embodiments having an anode protection layer in which a lithium anode layer is formed by pre-plating before application of a cathode and a comparative lithium battery which does not contain an anode protection layer;

FIG. 13 shows graphs of anode Coulombic efficiency vs. number of charge-discharge cycles for the batteries of FIG. 12; and

FIG. 14 shows graphs of Coulombic efficiency vs. number of charge-discharge cycles for electrochemical cells with APL-coated copper anode charge collectors and lithium counter electrodes, according to some embodiments having F8BT:PEO or polystyrene:PEO anode protection layers.

The drawings are not drawn to scale and have various viewpoints and perspectives. The drawings are some implementations and examples. Additionally, some components and/or operations may be separated into different blocks or combined into a single block for the purposes of discussion of some of the embodiments of the disclosed technology. Moreover, while the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. References to a layer “over” another layer when used in this application means that the layers may be in direct contact or one or more intervening layers are/may be present. References to a layer “on” another layer when used in this application means that the layers are in direct contact.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

The present inventors have found that the rate of decay of Coulombic efficiency of metal plating and stripping at an anode may be reduced by providing an anode protection layer which has a matrix containing a first material surrounding domains containing a second material wherein the first and second materials have different permeabilities to a liquid electrolyte. Such an anode protection layer may accordingly be used in a rechargeable metal battery.

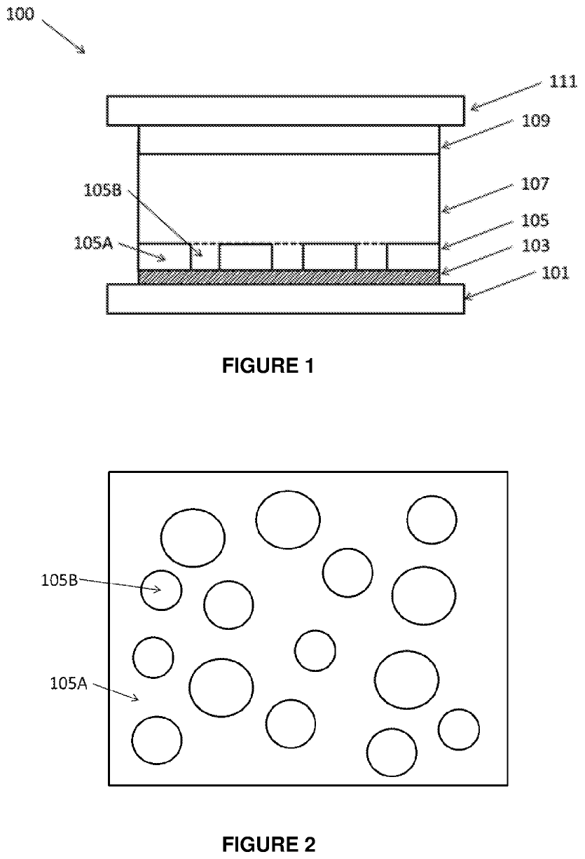

FIG. 1 illustrates a metal battery 100 according to some embodiments. The description hereinafter refers to lithium batteries having a lithium metal anode however it will be understood that other metals, e.g., sodium, may be used in place of lithium.

The lithium battery 100 has an anode current collector 101 in electrical contact with an anode 103 comprising a layer of lithium; a cathode current collector 111 in electrical contact with a cathode 109; a separator 107 disposed between the anode and cathode; and an anode protection structure disposed between the anode and the separator comprising an anode protection layer 105. Separator 107 is suitably in direct contact with the anode protection layer 105. Anode protection layer 105 is suitably in direct contact with anode 103.

In some embodiments, for example as illustrated in FIG. 1, the anode protection structure consists of the anode protection layer.

In some embodiments, the anode protection structure comprises two or more layers including the anode protection layer.

In other embodiments, one or more ion-permeable layers are disposed between anode 103 and anode protection layer 105. The one or more additional layers may comprise or consist of a layer of PEO.

The anode and cathode current collectors may each be formed from any suitable conducting material, preferably a metal, e.g., copper or aluminum.

With reference to FIG. 2, the anode protection layer 105 has a matrix 105A comprising or consisting of a first material and domains, or islands, 105B comprising or consisting of a second material surrounded by the matrix. At least some of the domains, optionally all of the domains, extend through the thickness of the anode protection layer.

Preferably, the first material makes up a majority of the mass of the matrix. Preferably, no more than 10 wt % of the matrix comprises the second material.

Preferably, the second material makes up a majority of the mass of the domains. Preferably, no more than 10 wt % of the domains comprise the first material.

Optionally, the metal battery contains only one anode protection layer. Optionally, the anode protection layer is the only layer disposed between the anode and the cathode having regions of different materials having differing ion permeability.

FIG. 2 illustrates randomly distributed domains 105B of differing sizes; in other embodiments, the domains are regularly spaced within the matrix and/or are of the same size.

The first and second materials are each preferably a polymer. The first material may be a crosslinked polymer. The second material may be a crosslinked polymer. A crosslinked first or second polymer of the anode protection layer may be less susceptible to dissolution in the liquid electrolyte and/or may increase mechanical robustness of the layer as compared to the corresponding non-crosslinked polymer.

The first material is less permeable to the electrolyte than the second material. Permeability of a first or second material as described herein may be indicated by a percentage increase in mass of the material upon immersion of a film of the material in the electrolyte solvent for 30 minutes at 20° C. Preferably, the mass increase of the second material is at least twice, optionally at least five times, that of the first material. The percentage mass increase of a film of a material is measured as described in the examples of the present application.

The matrix may contain only one first material or it may contain two or more first materials. The domains may contain only one second material or they may contain two or more second materials. The or each first material is less permeable to the electrolyte than the, or each, second material.

Optionally, domains 105B have a diameter in the range of about 100 nm-20 microns. In the case where the domains of an anode protection layer have differing sizes, the diameter is a mean average diameter.

Optionally, the domains make up 10⁻³⁰% of the surface area of the anode protection layer. The percentage surface area of the domains may be less than or equal to the mass of the second material as a percentage of the mass of the first and second materials.

Optionally, the first material: second material weight ratio of the anode protection layer is in the range of 60:40-99:1, optionally 70:30-90:10.

Optionally, the anode protection layer has a thickness in the range of about 10 nm-5 microns, optionally about 10 nm-150 nm, optionally about 20 nm-120 nm.

FIGS. 1 and 2 illustrate an anode protection layer in which the matrix comprises or consists of a first material which is less ion permeable than the second material disposed in the domains and in which the matrix is less permeable than the domains.

In other embodiments, the domains comprise the first material, the matrix comprises the second material, and the matrix is more permeable to the electrolyte than the domains.

### First Material

The first material is preferably an organic material, more preferably a polymer.

A film of the first polymer may swell to a lesser extent than a film of a second polymer when immersed in the solvent or solvents of the electrolyte.

The first polymer may be a semiconducting polymer (e.g., a conjugated polymer), in which case it is preferably non-doped.

Preferably, the first polymer has an electrical conductivity of less than 1 S/cm, optionally in the range of 10⁻³-10⁻⁶ S/cm.

In some embodiments, the first polymer is at least partially crystalline.

In some embodiments, the first polymer is a conjugated polymer, i.e., a polymer having a backbone in which repeat units are directly conjugated to one another. The conjugated polymer may be conjugated along the entire length of its backbone or may contain conjugated regions interrupted by non-conjugated regions. Optionally, the first polymer is partially crystalline.

In some embodiments, the first polymer is a non-conjugated polymer, optionally a polymer in which the polymer backbone is not conjugated, e.g., polystyrene.

The polymer may contain one or more arylene repeat units, optionally one or more repeat units selected from phenylene, fluorene, indenofluorene, naphthylene, anthracene, phenanthrene and dihydrophenanthrene repeat units, each of which may be unsubstituted or substituted with one or more substituents. The or each arylene repeat unit may be substituted with one or more substituents R¹ selected from:
linear, branched or cyclic C₁₋₂₀ alkyl wherein one or more non-adjacent, non-terminal C atoms may be replaced by O, S, NR², CO or COO wherein R² is a C₁₋₂₀ hydrocarbyl group and wherein one or more H atoms of the C₁₋₂₀ alkyl may be replaced with F;
a group of formula -(Ak)u-(Ar¹)v wherein Ak is a C₁₋₁₂ alkylene chain in which one or more C atoms may be replaced with O, S, CO or COO; u is 0 or 1; Ar¹ in each occurrence is independently an aromatic or heteroaromatic group which is unsubstituted or substituted with one or more substituents; and v is at least 1, optionally 1, 2 or 3; and
a crosslinkable group.

By “non-terminal” C atom of an alkyl group as used herein is meant a C atom of the alkyl other than the methyl C atom of a linear (n-alkyl) chain or the methyl C atoms of a branched alkyl chain.

Ar¹ is preferably phenyl.

Where present, substituents of Ar¹ may be a substituent R³ which in each occurrence is independently selected from C₁₋₂₀ alkyl wherein one or more non-adjacent, non-terminal C atoms may be replaced by O, S, NR², CO or COO and one or more H atoms of the C₁₋₂₀ alkyl may be replaced with F.

Crosslinkable groups include, without limitation, groups containing benzocyclobutene and groups containing a unit of formula —C(R⁴)═CH₂ wherein R⁴ is H or a substituent, optionally a C₁₋₁₂ alkyl.

The polymer may contain one or more heteroarylene repeat units, optionally one or more repeat units selected from thiophene, bithiophene, benzothiadiazole, pyridine, pyrimidine, pyrazine, triazole, imidazole, thiazole, quinoline, isoquinoline, indolizine, carbazole, acridine, and o-phenanthroline, each of which may be unsubstituted or substituted with one or more substituents R¹.

The polymer may contain one or more arylamine repeat units, optionally one or more triarylamine repeat units and/or 1,4-bis(diphenylamino)phenylene repeat units, each of which may be unsubstituted or substituted with one or more substituents R¹.

Preferably, the first polymer contains fluorene repeat units.

Exemplary first polymers or precursors thereof include F8BT and F8TFB:

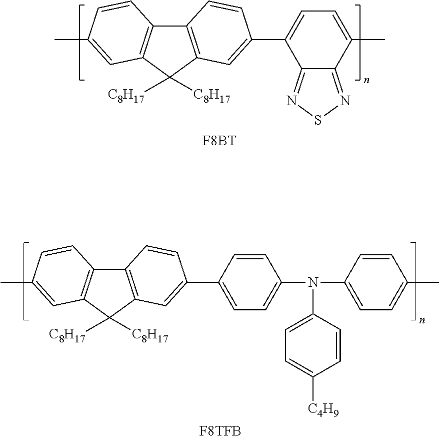

The first polymer may or may not be crosslinked. A precursor of the first polymer may be substituted with a crosslinkable group which is reacted following deposition of the first polymer precursor. Crosslinkable groups may be selected from groups described with reference to the first material.

The anode protection layer may contain two or more first materials, optionally at least one conjugated polymer first material and at least one non-conjugated polymer first material.

### Second Material

The second material is preferably an organic material, more preferably a polymer.

The second polymer may be amorphous.

The second polymer is preferably a non-conjugated polymer. The second polymer is preferably an electrically insulating polymer.

Exemplary second polymers include, without limitation, poly(ethylene oxide) (PEO) and polymethylmethacrylate (PMMA), polyethylenimine (PEI), polydimethylsiloxane (PDMS), polyvinylpyrrolidone (PVP), polyacrylamide (PAM) and polyacrylonitrile (PAN). PEO is a preferred second polymer.

The second polymer may or may not be crosslinked. A precursor of the second polymer may be substituted with a crosslinkable group which is reacted following deposition of the second polymer precursor.

The polystyrene-equivalent number-average molecular weight (Mn) measured by gel permeation chromatography of the first or second polymer described herein may independently be in the range of about 1×10³ to 1×10⁸, and preferably 1×10⁴ to 5×10⁶. The polystyrene-equivalent weight-average molecular weight (Mw) of the first and second polymers described herein may independently be 1×10 to 1×10⁸, and preferably 1×10⁴ to 1×10⁷.

### Anode Formation

In some embodiments, formation of the metal battery includes formation of a metal battery precursor in which an anode protection layer is formed over an anode current collector; a separator is placed between the anode protection layer and a cathode supported on a cathode current collector; and liquid electrolyte is introduced into the structure and the metal battery precursor may then be sealed.

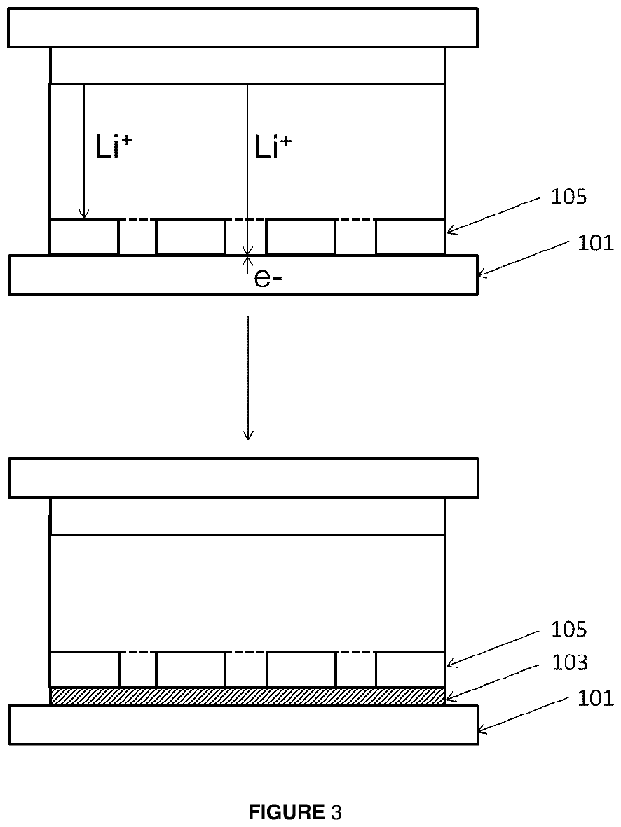

FIG. 3 illustrates a lithium battery precursor 100′ in which the anode protection layer 105 is formed directly on the anode current collector 101.

Application of a bias across the anode current collector and the cathode current collector causes lithium ions to migrate to the anode protection layer and through the ion-permeable domains 105B, thus forming the lithium battery having anode layer 103. The presence of the anode protection layer may result in a smooth lithium film, limiting the growth of “mossy” or dendritic lithium.

It will be understood that there is little or no transport of metal ions through the matrix 105A of the anode protection layer. As such, the first material may be a barrier material for limiting transport of metal ions through the anode protection structure. The metal ions are reduced at the anode current collector to cause plating of lithium on the anode current collector, thereby forming an anode 103 between the anode current collector 101 and the anode protection layer 105.

In some embodiments (not shown), a first lithium source, e.g., a layer of lithium metal, is used for a first formation of a lithium anode layer between the anode current collector and the anode protection layer and, following formation of the anode layer, the first lithium source is replaced with a cathode, e.g., a cathode as described herein. This “pre-plating” of lithium followed by replacement of the first lithium source with a cathode comprising lithium ions may mitigate loss of available lithium during charge/discharge cycles.

The lithium battery precursor 100′ illustrated in FIG. 3 does not contain a lithium anode layer. In other embodiments, the lithium battery may comprise an anode layer comprising lithium, for example a layer of lithium foil, onto which the anode protection layer is formed during fabrication of the battery and from which lithium may be stripped upon discharging of the lithium battery.

FIG. 3 illustrates a process of formation of a metal battery from the metal battery precursor by plating of lithium upon a first charging. It will be understood that a process of re-plating of lithium during recharging of the battery, following discharge of the lithium battery and stripping of the lithium anode, may be essentially the same.

### Anode Protection Layer Formulations

In formation of the anode protection layer, the first material or a precursor thereof and the second material or a precursor thereof may be deposited over the anode current collector.

In some embodiments, the first and second materials or precursors of one or both thereof are deposited directly onto the anode current collector.

In some embodiments, the first and second materials or precursors of one or both thereof are deposited onto a layer of lithium on the anode current collector, e.g., a layer of lithium foil.

The first material and the second material or precursor materials of one or both thereof may be deposited from a formulation comprising the materials dissolved or dispersed in one or more solvents.

Formation of the anode protection layer may comprise deposition of the formulation over the anode current collector followed by evaporation of the one or more solvents.

According to some embodiments, the formulation contains the liquid electrolyte. Upon deposition, the formulation may phase separate into the matrix and domains, the domains containing the electrolyte.

According to some embodiments, liquid electrolyte is applied to the surface of a film formed upon evaporation of the one or more solvents. The liquid electrolyte may be absorbed into the domains.

The electrolyte may form, with the second material, gel domains.

Formulations as described anywhere herein may be deposited by any suitable solution deposition technique including, without limitation, spin-coating, dip-coating, drop-casting, spray coating and blade coating.

Solvents may be selected according to their ability to dissolve or disperse the first material and/or second material. Exemplary solvents include, without limitation, benzene substituted with one or more substituents, optionally one or more substituents selected from C₁₋₁₂ alkyl, C₁₋₁₂ alkoxy; ethers; esters; fluorinated solvents; and mixtures thereof.

Optionally, the formulation is heat and/or vacuum treated following deposition. Optionally, heating is at a temperature in the range of about 50-180° C., optionally 50-120° C., optionally 50-100° C., optionally 80-130° C.

If a precursor of the first and/or second material has been deposited, it may be treated to convert it to its first material or second material form.

The first material and/or the second material may or may not be cross-linked.

In some embodiments, a precursor of a first material and/or a precursor of a second material as described anywhere herein is a non-crosslinked or partially crosslinked polymer. Conversion of the first or second precursor material to the first or second material comprises crosslinking of the precursor, preferably by irradiation thereof, e.g., irradiation with UV light.

In some embodiments, a precursor first material or precursor second material as described anywhere herein is a monomer or oligomer or a mixture of two or more compounds selected from monomers and oligomers. Conversion of a monomer, oligomer or a monomer and/or oligomer mixture to the first material or the second material comprises polymerization thereof. The polymer formed by polymerization may or may not be cross-linked. Optionally, a non-crosslinked polymer formed by said polymerization is crosslinked to form the first material and/or second material.

A non-crosslinked first or second precursor polymer may be crosslinked following deposition onto the anode current collector by any suitable technique including, without limitation, thermal treatment and/or irradiation of a crosslinkable material.

### Phase Separation

In some embodiments, the anode protection layer is a phase-separated layer.

The first and second materials or precursors thereof may be dissolved in a formulation which is deposited over the anode current collector and phase separated during evaporation of the one or more solvents to form the matrix and the domains.

In some embodiments, the first and second materials or precursors thereof may be separate materials blended in the formulation.

In some embodiments, the first and second materials or precursors thereof are each part of a block copolymer wherein the block copolymer has a first block comprising or consisting of the first material or a precursor thereof and a second block comprising or consisting of the second material or a precursor thereof.

In some embodiments, the average diameter of phase separated domains is in the range of about 0.5-5 microns, optionally about 1-5 microns.

First and second materials may be selected according to their differences in properties which cause them to phase separate including, without limitation, differences in polarity; polarizability or dispersive forces (i.e., ease of inducing transient dipole moments), and ability to engage in hydrogen bonding.

The size of the domains may be controlled by, without limitation, the proportion of first and second materials; the one or more solvents; the anode current collector surface, e.g., the anode current collector surface roughness, the film thickness and the rate of drying.

### Separator

The separator may be any suitable electrically insulating separator known to the skilled person.

The separator may be a porous separator. The porous separator is optionally not ion conducting. In use, a liquid electrolyte may be absorbed by the porous separator. The separator preferably comprises or consists of one or more polymers e.g., polyethylene, polypropylene (e.g., blown microfiber polypropylene) and combinations thereof. The separator may contain a polymer bilayer or trilayer, for example polypropylene-polyethylene or polypropylene-polyethylene-polypropylene. The separator may comprise or consist of a composite material, e.g., a polymer and ceramic composite for example an aramid fiber/ceramic composite. The separator may comprise or consist of glass fiber.

The separator may be a solid-state electrolyte e.g., a solid polymer electrolyte or solid metal oxide electrolyte. The separator may be a gel electrolyte.

In the case where the separator is a solid-state or gel electrolyte, the liquid electrolyte may not be required for ion transport between the cathode and the anode protection layer. According to these embodiments, in manufacture of the metal battery or metal battery precursor the anode protection layer may be formed with liquid electrolyte disposed within the domains for transport of metal ions through the anode protection layer.

In the case of a glass fiber separator, the present inventors have found that glass fibers may penetrate the anode protection layer, thereby providing a path for lithium ions to pass through the anode protection layer. According, in the case where a glass fiber separator is used, the anode protection layer may be a homogenous layer without domains formed as described herein, and may optionally consist of a single material, e.g., a first polymer as described herein.

### Electrolyte

The electrolyte may be an organic solvent or a blend of organic solvents having metal ions dissolved therein. The solvent is optionally an alkyl carbonate or a mixture of organic carbonates, for example propylene carbonate, ethylene carbonate, dimethyl carbonate, ethylmethyl carbonate, fluoroethylene carbonate, vinylene carbonate, dimethoxyethane, diglyme, triglyme, tetraglyme, tetrahydrofuran, dioxolane, acetonitrile, adiponitrile, dimethylsulfoxide, dimethylformamide, nitromethane, N-methylpyrrolidone, ionic liquids, deep eutectic solvents and mixtures thereof.

In a preferred embodiment, the solvent comprises a mixture of a non-fluorinated carbonate and a fluorinated carbonate, for example a mixture of propylene carbonate and fluoroethylene carbonate, for example as disclosed in T. Hou, G. Yang, N. Rajput, J. Self, S.-W. Park, J. Nanda, K. Persson, “The influence of FEC on the solvation structure and reduction reaction of LiPF₆/EC electrolytes and its implication for solid electrolyte interphase formation”, Nano Energy, 2019, 64, 103881, the contents of which are incorporated herein by reference.

A salt having a metal cation, may be dissolved in the electrolyte solvent, for example lithium bis(trifluoromethylsulfonyl)imide (LiTFSI) or lithium hexafluorophosphate Li bis(fluorosulfonyl)imide (LiFSI), LiAsF₆, LiSbF₆, LiCIO₄, Li bisoxalatoborane, LiBF₄, LiNO₃, Li halides, Li dicyanamide and combinations thereof.

### Cathode

The cathode may be any cathode known to the skilled person capable of releasing and reabsorbing metal ions for example, in the case of a lithium battery, LiCoO₂, LiNixMnyCoz (e.g., NMC 622 and 811), LiFePO₄ (LFP), LiMnO₂, LiNiCoAIO₂, V₂O₅, sulfur, and (in the case of a lithium-air battery) oxygen.

### Applications

The metal battery as described herein is preferably a lithium battery. The metal battery as described herein is preferably a secondary metal battery.

The metal battery as described herein may be used in a wide variety of applications including, without limitation, portable electronic devices such as phones, tablets and laptops; vehicles including cars, electric motorbikes, electric bicycles and drones; medical devices; wearable electronic devices; and energy storage for storage of energy from renewable energy sources such as solar, wind or hydroelectric power sources.

### EXAMPLES

### Ion Permeability and Polymer Solubility

Ion permeability and solubility of F8BT, PMMA, PEO, and PVDF for use in the anode protection layer were assessed using gravimetric methods on a glass substrate.

Initially the glass substrate was weighed prior to depositing a polymer. The polymer was then deposited by spin coating or drop casting from a solution and the solvent was removed to leave a dry film. The mass of the glass substrate plus the dry polymer film was then weighed.

Propylene carbonate was then applied to the polymer on the glass substrate and left to stand for a period of time of no less than 30 minutes. The excess solvent was then removed and the polymer-coated glass was weighed for a third time. Finally, the polymer-coated glass was baked to remove all incorporated solvent and weighed again, noting any mass decrease from the second weighing. Mass loss in this step represents the amount of material dissolved from the polymer coating and can be calculated as a percentage of the original combined weight of the polymer and glass substrate. The amount of swelling was determined by taking the difference between weight of the wetted film (third weight measurement) and the final dry weight of the film. The swelling constitutes the mass increase of the film due to uptake of solvent as a percentage of the final dry weight, thus taking into account any dissolution than may have occurred during exposure to solvent.

TABLE 1

| | Average | Average |
|---|---|---|
| | swelling | mass loss |
| Polymer | [mass %] | [mass %] |
| F8BT | 22 | 3 |
| PMMA | 228 | 47 |
| PEO | 55 | 7 |
| PVDF | 26 | 2 |

F8BT has relatively low swelling, indicating relatively low ion permeability when used as an anode protection layer, and PMMA has high swelling, indicating relatively high ion permeability when used as an anode protection layer.

### Phase Separation Morphology

After spin coating on a given substrate from solution at a spin rate of 1000 rpm, the phase separation morphology was investigated using optical and fluorescence microscopy as well as scanning electron microscopy (SEM) and atomic force microscopy (AFM).

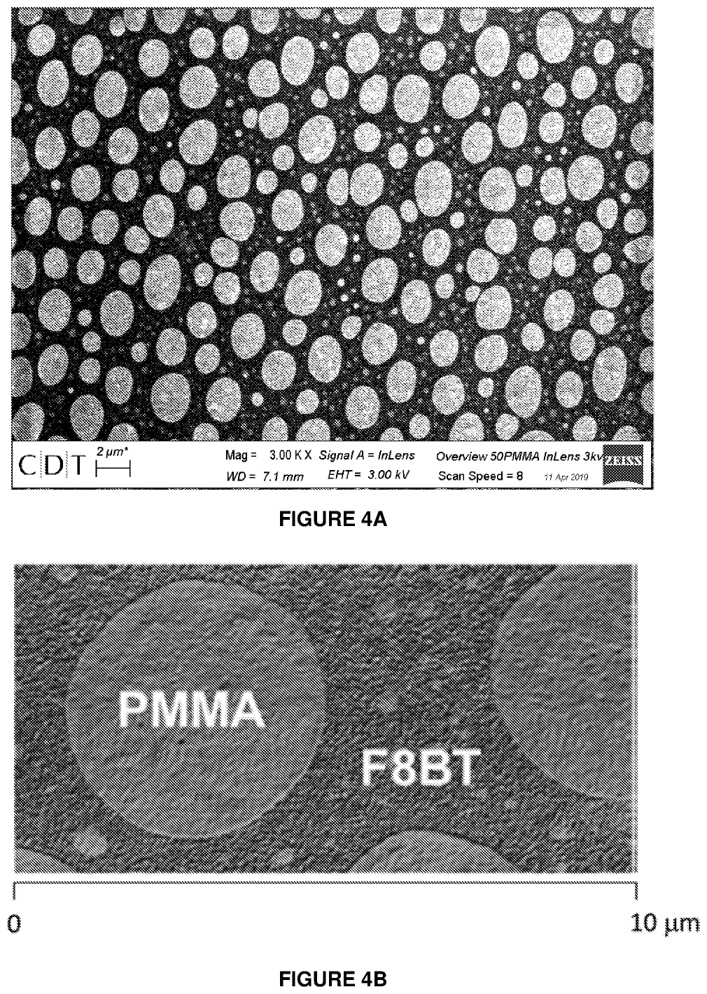

F8BT-PMMA 75:25 blends spin coated on glass from toluene at a spin rate of 1000 ppm, resulted in films with a thickness of ˜50 nm, exhibiting a phase separation morphology consisting of circular domains of PMMA (˜1-2 μm diameter) densely packed (˜2-4 μm apart) within a matrix of F8BT, as shown in the scanning electron microscopy (SEM) and atomic force microscopy (AFM) of FIGS. 4A and 4B, respectively.

The ˜50 nm thick F8BT-PMMA 75:25 blend films spin coated on Cu from toluene exhibit a phase separation morphology in which domains of F8BT and PMMA align in striations on the Cu foil surface, without the formation of isolated circular domains of PMMA.

F8BT-PEO 75:25 blends spin coated on glass from toluene, resulting in films with a thickness of ˜50 nm, exhibit a similar phase separation morphology consisting of circular domains of PEO (˜2-5 μm diameter) densely packed within a matrix of F8BT. When the same ratio of F8BT-PEO is spin coated from a toluene solution of twice the concentration, giving films with a thickness of ˜110 nm, the circular PEO domains are observed to form in roughly two size groupings: one with diameters of ˜1-2 μm and other with diameters of ˜5-10 μm. Further, F8BT-PEO 75:25 blends spin coated on glass from the higher boiling dichlorobenzene (DCB) solvent, resulting in films with a thickness of ˜40 nm, a phase separation morphology comprising sparsely packed circular domains of PEO (˜1-2 μm diameter) within a matrix of F8BT. PEO domains are also apparent below the F8BT surface but do not seem to extend through the F8BT surface.

The ˜50 nm thick F8BT-PEO 75:25 blend films spin coated on Cu foil from toluene exhibit a phase separation morphology in which isolated circular domains of PEO within a matrix of F8BT. In some regions on the Cu foil surface there is a higher density of Circular PEO domains lying in striations on the cu surface. However, ˜30 nm thick F8BT-PEO 75:25 blend films spin coated on Cu foil from toluene do not exhibit isolated circular domains of PEO but show a phase separation morphology in which domains of F8BT and PEO align in striations on the Cu foil surface, similar to that of F8BT-PMMA on Cu foil.

F8BT-PEO 90:10 blends spin coated on glass from toluene, resulting in films with a thickness of ˜60 nm, exhibit a similar phase separation structure to the 75:25 blend but with smaller (0.5-2 μm) PEO domains packed within the matrix of F8BT.

F8BT-PEO 25:75 blends spin coated on glass from toluene, resulting in films with a thickness of ˜80 nm, exhibit an ‘inverted’ phase separation morphology consisting of circular domains of F8BT (˜1-2 μm) within a matrix of PEO.

The phase separation results using F8BT are summarized in Table 2.

TABLE 2

| | | | | Film | |
|---|---|---|---|---|---|
| Polymers | Blend | | | thickness | |
| in blend | ratio | Solvent | Substrate | [nm] | Morphology |
| F8BT-PMMA | 75:25 | Toluene | Glass | 50 | Circular domains of |
| | | | | | PMMA (~1-2 μm) |
| | | | | | in F8BT matrix. |
| F8BT-PMMA | 75:25 | Toluene | Cu foil | 50 | Domains of F8BT and |
| | | | | | PMMA aligning in |
| | | | | | striations on the Cu foil. |
| | | | | | No circular domains. |
| F8BT-PEO | 75:25 | Toluene | Glass | 50 | Circular domains of |
| | | | | | PEO (~2-5 μm) in |
| | | | | | F8BT matrix. |
| F8BT-PEO | 75:25 | Toluene | Glass | 110 | Circular PEO domains |
| | | | | | in two size groupings: |
| | | | | | one of ~1-2 μm |
| | | | | | diameters and one |
| | | | | | of ~5-10 μm diameters. |
| F8BT-PEO | 75:25 | DCB | Glass | 40 | Sparse distribution of |
| | | | | | circular PEO |
| | | | | | domains (~1-2 μm) |
| | | | | | in F8BT matrix with |
| | | | | | subsurface PEO domains |
| | | | | | visible. |
| F8BT-PEO | 75:25 | Toluene | Cu foil | 50 | Circular domains of |
| | | | | | PEO (~2-5 μm) in F8BT |
| | | | | | matrix. |
| F8BT-PEO | 75:25 | Toluene | Cu foil | 30 | Domains of F8BT and |
| | | | | | PMMA aligning in |
| | | | | | striations on the Cu foil. |
| | | | | | No circular domains. |
| F8BT-PEO | 90:10 | Toluene | Glass | 60 | Circular domains of |
| | | | | | PEO (~0.5-2 μm) in |
| | | | | | F8BT matrix. |
| F8BT-PEO | 25:75 | Toluene | Glass | 80 | Circular domains of |
| | | | | | F8BT (~1-2 μm) in PEO |
| | | | | | matrix. |

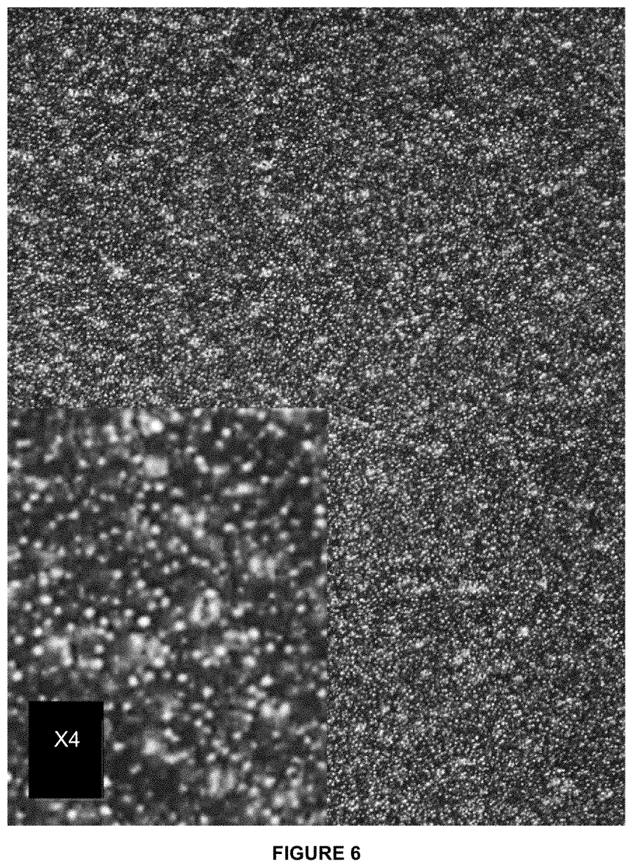

A film was formed by spin-coating a 30 nm polystyrene:poly(ethylene oxide) 75:25 blend-film on glass. With reference to FIG. 6, dark field microscopy revealed the presence of micron-sized, randomly distributed PEO domains (white dots) within the PS matrix (dark film).

When in contact with liquid electrolyte, these PEO domains were found to swell and form ionically conductive PEO-electrolyte gel channels through the layer.

### Model Electrochemical Cell 1

Lithium plating using an anode protection layer of F8BT only and using an anode protection layer of phase-separated F8BT and PMMA (50:50) was compared. An electrochemical cell was assembled containing about 5 mL of 1 M LiTFSI (SigmaAldrich) in propylene carbonate electrolyte (SigmaAldrich), a Li wire (SigmaAldrich) counter electrode, a Cu wire (SigmaAldrich) reference electrode, and a working electrode in a nitrogen-filled glovebox. The electrochemical cell was sparged with dry argon before testing and kept under an atmosphere of argon during the test. The working electrode comprises either a thin glass plate coated on one side with ˜700 nm of Cu (Cu on glass) or this Cu on glass plate coated on the copper side with an anode protection layer. FIG. 4B shows an atomic force microscopy image of the surface of a Cu on glass plate coated with a F8BT-PMMA anode protection layer.

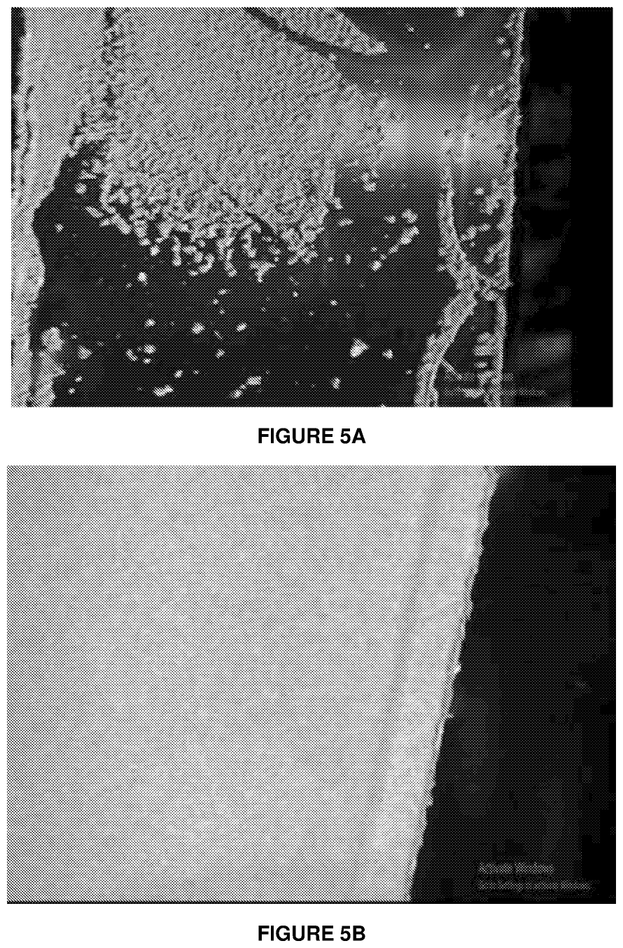

A galvanostatic cycling experiment was carried out using the electrochemical cell with a CH instruments CHl660D potentiostat. In this experiment a plating current density was applied to the working electrode for 500 seconds followed by the application of a stripping current density to a cut-off voltage of −0.4 V vs. the Cu reference electrode. The current densities were increased from 0.01 mA·cm⁻² to 2 mA·cm⁻² in gradual steps. FIG. 5A shows a Cu on glass plate coated with an F8BT-only anode protection layer after cycling at 2 mA·cm⁻². FIG. 5B shows a Cu on glass plate coated with a F8BT-PMMA anode protection layer after cycling at 2 mA·cm⁻². FIG. 5B shows smooth Li plating enabled by the blend anode protection layer in contrast to the dendritic plating observed on the F8BT-only Cu on glass electrode.

### Model Electrochemical Cell 2

An electrochemical cell was formed using 2032-type coin cell devices (casings purchased from Cambridge Energy Solutions) in which an anode protection layer was formed by spin-coating a 75:25 F8BT-PMMA blend onto a current collector of a copper foil disc (⅝ inch diameter). The battery had a glass fiber separator (Whatman), 1 M LiTFSI (Solvionic) in propylene carbonate electrolyte (SigmaAldrich), and a Li metal disc (MTI corp.) counter electrode. The cells also contained a parafilm gasket ring with a hole diameter of roughly 0.5 cm, which was placed between the coated copper anode current collector and the separator. The electrolyte and all coin cell devices were prepared or constructed in a rigorously dry and oxygen-free Ar-filled MBraun™ glovebox.

### Comparative Model Electrochemical Cell 2A

A cell was formed as described for Model Electrochemical Cell 2 except that the anode protection layer was formed by spin-coating F8BT only.

### Comparative Model Electrochemical Cell 2B

A cell was formed as described for Model Electrochemical Cell 2 except that the anode protection layer was formed by spin-coating PMMA only.

A galvanostatic cycling experiment was carried out by applying a plating current density of 0.5 mA·cm⁻² to the copper working electrode for 1 hour, followed by the application of an equal stripping current density to a cut-off voltage of 1 or 2 V versus the Li/Li⁺ redox couple, referred to hereafter as vs. Li.

The electrochemical measurement was performed on a Lanhe™ battery cycler (Wuhan Land Electronics Co. Ltd.). Cycling Coulombic efficiency (i.e., charge out/charge in) was determined by calculating the ratio of the charge passed during stripping to the total charge passed during plating.

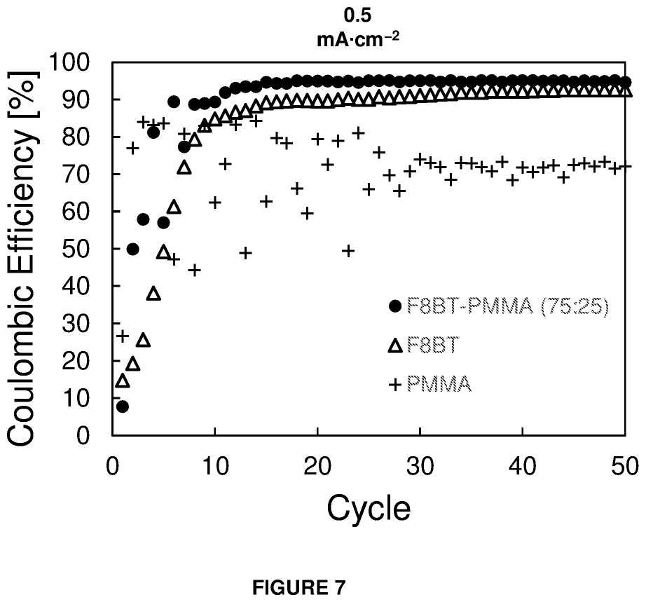

With reference to FIG. 7, Model Electrochemical Cell 2_exhibits higher Coulombic efficiencies during initial stages of cycling at 0.5 mA·cm⁻² than Comparative Model Cells 2A and 2B.

### Electrochemical Cells 3A-3D

An electrochemical cell was formed using 2032-type coin cell devices (casings purchased from Cambridge Energy Solutions) in which an anode protection layer was formed by spin-coating materials shown in Table 3 from toluene solution onto a current collector of a copper foil disc (⅝ inch diameter). The battery had a porous glass fiber separator and a porous polymer separator between the anode protection layer and the porous glass fiber separator, 1 M LiTFSI (Solvionic) in propylene carbonate electrolyte (SigmaAldrich), and a Li metal disc (MTI corp.) counter electrode. The electrolyte and all coin cell device were prepared or constructed in a rigorously dry and oxygen-free Ar-filled MBraun™ glovebox.

TABLE 3

| Electrochemical Cell | Anode protection layer |
|---|---|
| Example Cell 3A | F8BT:PEO (50:50 w/w) |
| Example Cell 3B | F8BT:PEO (75:25 w/w) |
| Example Cell 3C | F8BT:PMMA (50:50 w/w) |
| Example Cell 3D | F8BT:PMMA (75:25 w/w) |
| Comparative Cell 3 | F8BT |

A galvanostatic cycling experiment was carried out by applying a plating current density of 0.6 mA·cm⁻² to the copper working electrode for 1 hour, followed by the application of an equal stripping current density to a cut-off voltage of 1 V versus the Li/Li⁺ redox couple, referred to hereafter as vs. Li.

The electrochemical measurement was performed on a Lanhe™ battery cycler (Wuhan Land Electronics Co. Ltd.). Cycling Coulombic efficiency (i.e., charge out/charge in) was determined by calculating the ratio of the charge passed during stripping to the total charge passed during plating.

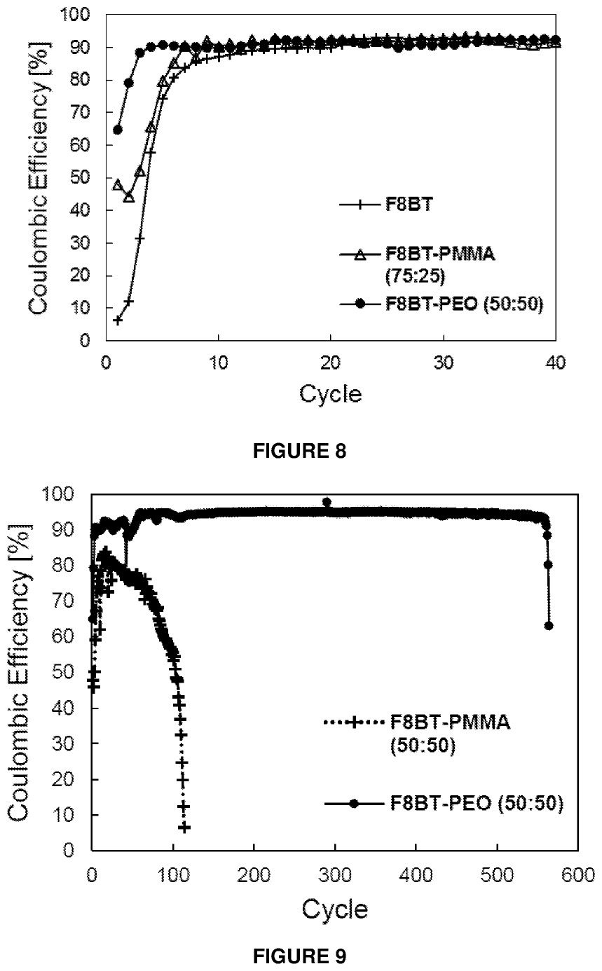

With reference to FIG. 8, Example Cells 3A and 3C reach ˜90% efficiency faster than Comparative Cell 3.

The current densities of Example Cells 3A-3 Dwere increased by 0.2 mA·cm⁻² every 20 cycles until a current density of 2 mA·cm⁻² was reached.

With reference to FIG. 9, Example Cell 3A in which the anode protection layer contains 50 wt % PEO exhibits higher Coulombic efficiency than Example Cell 3C containing 50 wt % PMMA and exhibits stable cycling for ˜550 cycles as compared to about 20 cycles for Example Cell 3C.

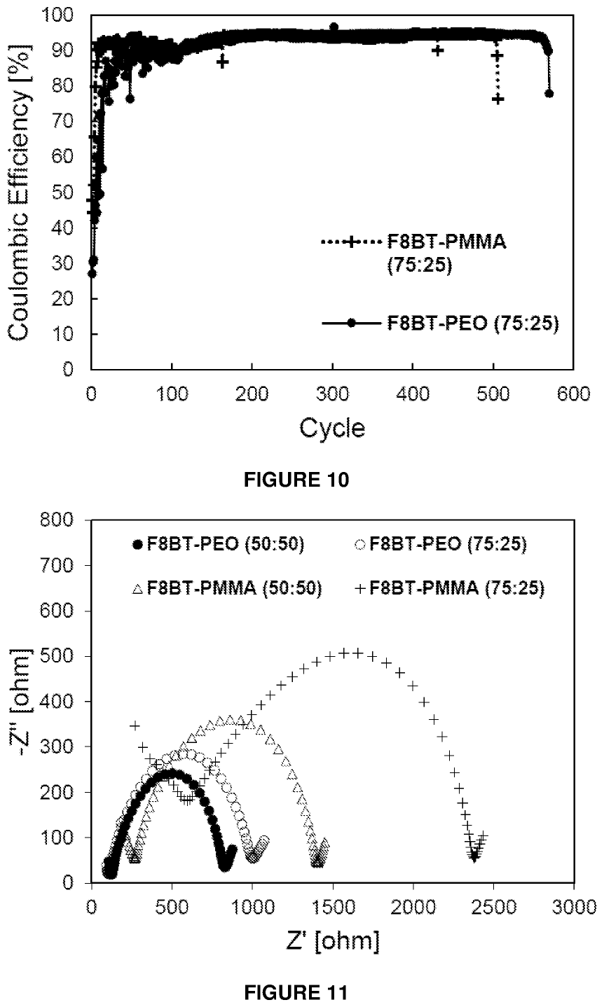

With reference to FIG. 10, Example Cell 3B in which the anode protection layer contains 25 wt % PEO exhibits a similar Coulombic efficiency to Example Cell 3D containing 25 wt % PMMA. Example Cell 3B has significantly longer cycling stability than Example Cell 3D.

### EIS Measurements

Pseudo-symmetric Li|Li cells were formed as described above and electrochemical impedance spectroscopic (EIS) experiments were conducted during an initial period of galvanostatic plating at 0.5 mA·cm⁻² for 10 minutes of cells having a structure as described for Example Cells 3A-3D. EIS measurements were conducted using a 5 mV AC current applied in a frequency range between 1 MHz and 1 Hz.

With reference to FIG. 11, EIS measurements for Example Cells 3A and 3B show similar impedance values and both have lower impedance than either Example Cells 3C or 3D.

### Electrochemical Cell Example 4A

An electrochemical cell was formed using 2032-type coin cell devices (casings purchased from Cambridge Energy Solutions) in which an anode protection layer was formed by spin-coating 20-100 nm of a blend of F8BT and PEO (75:25 w:w %) from toluene solution onto a current collector of a copper foil disc (⅝ inch diameter). The battery had a porous polymer separator, 1 M LiTFSI (Solvionic) in propylene carbonate electrolyte (SigmaAldrich), and a Li metal disc (MTI corp.) counter electrode. The porous polymer separator was in direct contact with the anode protection layer.

A pre-plating treatment was performed by applying a current of 0.5 mAcm⁻² to give a total of 0.2 mAh of plated Li on the Cu electrode. After the pre-plating the Li disc was removed and replaced by a lithium iron phosphate (LFP) cathode (LFP on aluminum foil from MTI corp., 127 mAh/g) with a theoretical capacity of 1.93 mAh.

The electrolyte, all coin cell devices, and pre-plating were prepared or conducted in a rigorously dry and oxygen-free Ar-filled MBraun™ glovebox.

### Electrochemical Cell Example 4B

A cell was prepared as described for Electrochemical Cell Example 4A except that 5 wt % fluorethylene carbonate (FEC, Alfa Aesar) was added to the 1 M LiTFSI in propylene carbonate electrolyte.

### Comparative Electrochemical Cell 4

A cell was prepared as described for Electrochemical Cell Example 4A except that the anode protection layer was omitted.

A galvanostatic cycling experiment was carried out for Electrochemical Cell Examples 4A and 4B and Comparative Electrochemical Cell 4 by applying a charging current of 0.1 C to a cut-off voltage of 3.8 V followed by the application of a discharge current of 0.2 C to a cut-off voltage of 2.5 V cell voltage. These measurements were performed on an Arbin™ battery cycler (Arbin Instruments).

Cycling Coulombic efficiency was determined by calculating the ratio of the charge passed during discharge to the total charge passed during charge.

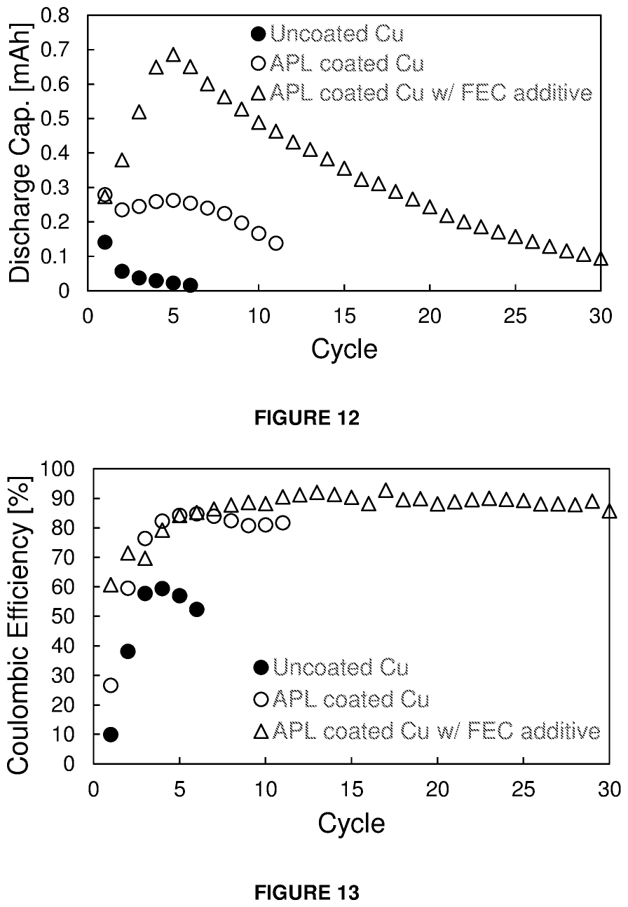

With reference to FIG. 12, the galvanostatic cycling data for Electrochemical Cell Examples 4A and 4B so better charge/discharge capacity retention, resulting in longer cycle life, than Comparative Electrochemical Cell 4, which showed close to complete loss of charge/discharge capacity at cycle six, whereas Electrochemical Cell Example 4A shows stable retention of capacity around 0.2 mAh. Incorporation of fluorethylene carbonate as in Electrochemical Cell Example 4B resulted in considerably improved capacity retention (which led to longer cycle lifetime (>30 cycles).

With reference to FIG. 13, higher Coulombic efficiencies were achieved over 11 cycles by Electrochemical Cell Examples 4A and 4B as compared to Comparative Electrochemical Cell 4, and Electrochemical Cell Example 4B containing the FEC electrolyte additive exhibits Coulombic efficiencies around 90% over at least 30 cycles.

### Electrochemical Cell Example 5A

A 2032-type coin cell (casings purchased from Cambridge Energy Solutions) cell was formed comprising a copper electrode having a 30 nm anode protection layer of polystyrene:PEO 75:25 wt % or F8BT:PEO 75:25 wt %, a porous polymer separator (Pervio™; Sumitomo Chemical) in direct contact with the anode protection layer, 1 M LiTFSI (Solvionic) in propylene carbonate electrolyte (SigmaAldrich), and a Li metal disc counter-electrode. The electrolyte and coin cell were prepared or constructed in a rigorously dry and oxygen-free Ar-filled MBraun™ glovebox.

### Electrochemical Cell Example 5B

A cell was prepared as described for Electrochemical Cell Example 5A except polystyrene:PEO 75:25 wt % was replaced with F8BT:PEO 75:25 wt %.

A galvanostatic cycling experiment was carried out by applying a plating current density of 0.6 mA·cm⁻² to the working electrode for 1 hour followed by the application of a stripping current density of 0.6 mA·cm⁻² to a cut-off voltage of 1 V versus the Li/Li⁺ redox couple, referred to hereafter as vs. Li.

In some experiments the current densities were increased by 0.2 mA·cm⁻² every 20 cycles until a current density of 2 mA·cm⁻² was reached.

The electrochemical measurements were performed on an Arbin battery cycler (Arbin Instruments). Cycling Coulombic efficiency was determined by calculating the ratio of the charge passed during stripping to the total charge passed during plating.

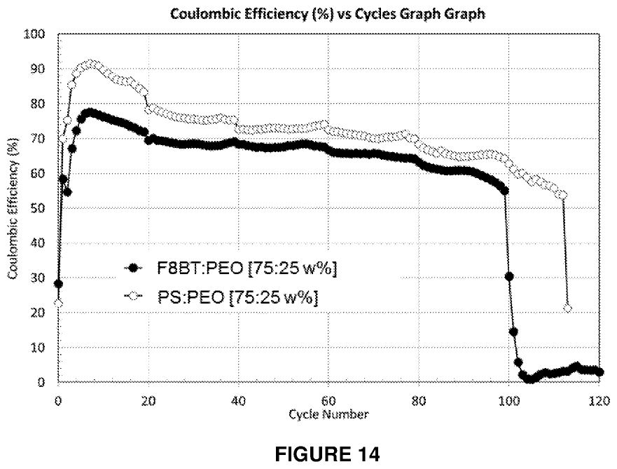

With reference to FIG. 14, a higher initial Coulombic efficiency and slightly longer cycle lifetime is achieved with Cell Example 5A as compared to Cell Example 5B.

1. A metal battery comprising:
an anode;
an anode current collector in electrical contact with the anode;
a cathode;
a cathode current collector in electrical contact with the cathode;
a separator disposed between the anode and cathode;
a liquid electrolyte; and
an anode protection structure comprising an anode protection layer disposed between the anode and the separator,
wherein the anode protection layer comprises a matrix and domains within the matrix; one of the matrix and domains comprises a first material; and the other of the matrix and domains comprises a second material, and wherein the first material is less permeable by the electrolyte than the second material.

2. The metal battery according to claim 1 wherein the matrix comprises the first material and the domains comprise the second material.

3. The metal battery according to claim 2 wherein the first material makes up a majority of the weight of the matrix and the second material makes up a majority of the weight of the domains.

4. The metal battery according to claim 1 wherein at least one of the first and second materials is a polymer.

5. The metal battery according to claim 4 wherein the first material and the second materials are polymers and wherein a percentage mass increase of the second material upon immersion in a solvent of the electrolyte is at least two times that of the first material.

6. The metal battery according to claim 4 wherein the first material is a conjugated polymer.

7. The metal battery according to claim 6 wherein the conjugated polymer is not doped.

8. The metal battery according to claim 4 wherein the first material is a non-conjugated polymer.

9. The metal battery according to claim 4 wherein the second polymer is selected from polyacrylates; polymethacrylates; and poly(ethylene oxide).

10. The metal battery according to claim 1 wherein the anode protection layer is a phase-separated layer.

11. The metal battery according to claim 1 wherein the anode protection layer has an electrical conductivity of less than 1 S/cm.

12. The metal battery according to claim 1 wherein the metal battery is a lithium battery and the metal ion is a lithium ion.

13. The metal battery according to claim 1 wherein the anode protection structure consists of the anode protection layer.

14. The metal battery according to claim 1 wherein the anode protection layer is in direct contact with the anode layer.

15. (canceled)

16. The metal battery according to claim 1 wherein the separator comprises a solid-state electrolyte or gel electrolyte.

17. The metal battery according to claim 1 wherein the metal battery is rechargeable.

18. A method of forming a metal battery or an anode-free precursor thereof of claim 1, the method comprising:
forming an anode protection structure comprising an anode protection layer over an anode current collector; and
providing a cathode in electrical contact with a cathode current collector, a separator between the anode current collector and the cathode, and a liquid electrolyte providing an ion conducting path between the anode current collector and the cathode,
wherein formation of the anode protection layer comprises depositing the first material and the second material over the anode current collector.

19. The method according to claim 18 wherein the first material and the second material are deposited from a formulation comprising the first material, the second material and one or more solvents; and evaporating the one or more solvents.

20. (canceled)

21. (canceled)

22. A metal battery precursor comprising:
an anode current collector;
a cathode;
a cathode current collector in electrical contact with the cathode;
a separator disposed between the anode current collector and cathode;
a liquid electrolyte; and
an anode protection structure comprising an anode protection layer disposed between the anode current collector and the separator;
wherein the anode protection layer comprises a matrix comprising a first material and domains comprising a second material within the matrix, the first material being less permeable by the electrolyte than the second material.

23. (canceled)

24. A metal battery comprising:
an anode;
an anode current collector in electrical contact with the anode;
a cathode;
a cathode current collector in electrical contact with the cathode;
a separator comprising glass fiber disposed between the anode and cathode; and
an anode protection structure disposed between the anode and the separator,
wherein the separator is in direct contact with the anode protection structure.

25. (canceled)

26. (canceled)
